(19) United States
(12) Patent Application Publication
(10) Pub. No.: US 2012/0091625 A1
(43) Pub. Date: Apr. 19, 2012

(54) FILM FOR PRODUCTION OF COMPOSITE MATERIAL ARTEFACTS, PRODUCTION METHOD OF SAID FILM AND PRODUCTION METHOD OF COMPOSITE MATERIAL ARTEFACTS USING SAID FILM

(76) Inventor: Paolo Peruzza, Conegliano (IT)

(21) Appl. No.: 13/260,190

(22) PCT Filed: Mar. 23, 2010
(86) PCT No.: PCT/EP10/53768

§ 371 Date: Dec. 28, 2011

(30) Foreign Application Priority Data
Mar. 23, 2009 (IT) TV2009A 000056

(51) Int. Cl. B28B 7/38; B28B 7/22

(52) U.S. Cl. 264/255; 427/133; 425/470

(57) ABSTRACT

A resin constraint film to be used in production of composite material artefacts; the constraint film being formed by a supporting film made of biaxially oriented polypropylene, by an intermediate layer of release chemical product that coats the front face of the supporting film intended to come into contact with the semi-finished product which will give rise to the composite material artefact, and by a surface layer of metal coating material applied onto the intermediate layer via vacuum vaporisation deposition.

### TECHNICAL FIELD

The present invention relates to a film for production of composit-material artefacts, to a production method of said film, and to a production method of composit-material artefacts using said film.

More in detail, the present invention relates to a resin constraint film to be used in the production of composit-material artefacts having a tubular shape; use to which the following description refers purely by way of example, without this implying any loss of generality.

### BACKGROUND ART

As is known, composit-material artefacts having a tubular shape and a non-tubular shape, are basically formed by one or more overlapped layers of glass fibres and/or carbon fibres and/or aramidic fibres and/or cotton, linen, hemp or other organic material fibres, appropriately braided and/or overlapped to one another and embedded in a matrix of epoxy, phenolic or polyester thermosetting resin.

In some production processes, the composit-material artefact may be obtained from a semi-finished mat of fibres preimpregnated with resin still in a semisolid state (also called “prepreg”), which is shaped so as to follow the shape of the artefact to be obtained, and is then subjected to a thermal curing cycle during which the polymerization of the resin occurs, with a subsequent irreversible solidification thereof.

In the case of composit-material artefacts having a tubular shape, the semi-finished product is wound about a metal chuck and is then placed within the oven where the polymerization of the resin takes place, beforehand the same has been wound with a plastic material tape (generally polypropylene) which serves to retain the resin within the semi-finished product until the resin is totally set.

In most cases, the resin constraint tape is then removed from the composit-material artefact at the end of the resin polymerization process.

The need to use the resin constraint tape is due to the fact that, during the initial phase of the polymerization process, the thermosetting resin increases in volume and undergoes an increase of its fluidity, so that, if it is not keep in place, it tends to pour out of the semi-finished product by gravity before solidifying, compromising the structural integrity of the artefact.

Finally, for some uses, the surface of the composit-material artefact needs to be coloured.

In this case, the production process provides that a coloured paint layer is applied by spray or brush directly on the surface of the composit-material artefact, after the thermosetting resin has completed the polymerization process; or provides that a coloured paint layer is applied by spray or brush directly on the surface of the semi-finished product, before the resin polymerisation process takes place.

In this second case, during the polymerisation process, the thermosetting resin can stably incorporate the particles of coloured pigment therein thus improving the surface finishing of the artefact.

In fact, as is known, the coloured paint consists of a liquid and substantially transparent mixture of resin and diluent/solvent which are finely mixed together, and of a variable amount of base pigment particles (i.e. finely ground particles of the desired colouring substance) suspended in the transparent liquid mixture. The diluent/solvent has the function to maintain the resin in a liquid state, while the resin is the chemical substance which grips to the surface of the artefact when it is still in a liquid phase, and which stably sticks to the surface of the artefact retaining the pigment particles when the diluent/solvent is naturally dispersed by evaporation.

If the resin used in the coloured paint is chemically compatible with the thermosetting resin of the composit-material artefact, during the initial phase of the polymerization process, the thermosetting resin positioned at the surface of the composit-material artefact can incorporate therein the resin and the pigment particles which form the coloured paint, thus colouring on the surface of the composit-material artefact.

As specified in Japanese patents JP11309797 and JP2000062032 and in European patent EP1621322, in recent years some manufacturers of tubular-shaped composit-material artefacts, in order to simplify and speed up the production process, started applying the coloured paint directly on the face of the polypropylene tape which is intended to come into direct contact with the surface of the composit-material artefact, then delegating to the thermosetting resin of the artefact the task to incorporate therein, during the polymerization process, the pigment particles present on the surface of the tape.

In this case, the coloured paint must necessarily be applied with a brush or by means of screen printing, directly on the “non-treated” face of the polypropylene constraint tape, i.e. on the face that has, by definition, a surface tension having a value lower than 38 Dyne/centimetre, so as to generate medium-weak molecular bonds between the coloured paint and the surface of the polypropylene constraint tape.

In fact it is well known that, if the thermosetting resin on the surface of the composit-material artefact comes into direct contact with a polypropylene surface with a surface tension of more than 38 Dyne/centimetre, it permanently binds to the constraint tape so that the tape may be only removed by mechanical surface abrasion by sandpaper or the like. A processing that would irreparably damage the surface of the composit-material artefact.

Obviously, the constraint tape is used in the production and colouring of the composit-material artefact after the very thin layer of coloured paint has dried on the surface of the tape.

Even having drastically reduced the production and colouring costs of composit-material artefacts, the use of polypropylene constraint tape with a face coloured by screen printing, does not allow to realize surfaces with colours having intensity, brightness and shine comparable to those obtainable by directly spray or brush painting the composit-material artefact at the end of the polymerization process of the thermosetting resin.

In the end, via the above described production process it is not possible to give the surface of the composit-material artefact a metal look. As a matter of fact, in order to obtain this kind of surface finishing, the manufacturers of composit-material artefacts generally use semi-finished mats in which fibres undergo a surface metallization process before being impregnated with thermosetting resin.

Unfortunately, the final aesthetic result does not compensate the considerable increase in production costs: the surface metallization of the fibres of the semi-finished product is indeed the result of a particularly long and expensive surface treatment, and the composit-material artefact, at the end of the polymerization of the resin, does not have a surface coating with a uniform metal look.

### DISCLOSURE OF INVENTION

It is therefore an aim of the present invention to manufacture a constraint film for the production of composit-material artefacts, in the form of a tape or sheet, which permits to realize, on composit-material artefacts, coloured surfaces having colours with intensity, brightness, shine and/or metal look comparable to those that may be obtained by directly spray or brush painting the composit-material artefact at the end of the polymerization process of the thermosetting resin.

In compliance with the above aims, according to the present invention a constraint film for production of composit-material artefacts is provided as specified in claim 1 and preferably, though not necessarily, in any one of the dependent claims.

According to the present invention, a production method of a constraint film for production of composit-material artefacts, is also provided as specified in claim 9 and preferably, though not necessarily, in any one of the dependent claims.

Finally according to the present invention, a production method of composit-material artefacts is provided as specified in claim 17 and preferably, though not necessarily, in any one of the dependent claims.

### BRIEF DESCRIPTION OF THE DRAWINGS

The present invention will now be described with reference to the accompanying drawings, which show a non-limitative embodiment thereof, in which:

FIG. 1 schematically shows a film for production of composit-material artefacts realized according to the teachings of the present invention; whereas

FIGS. 2, 3, and 4 schematically show the various steps of a method for production of composit-material artefacts, carried out according to the teachings of the present invention.

### BEST MODE FOR CARRYING OUT THE INVENTION

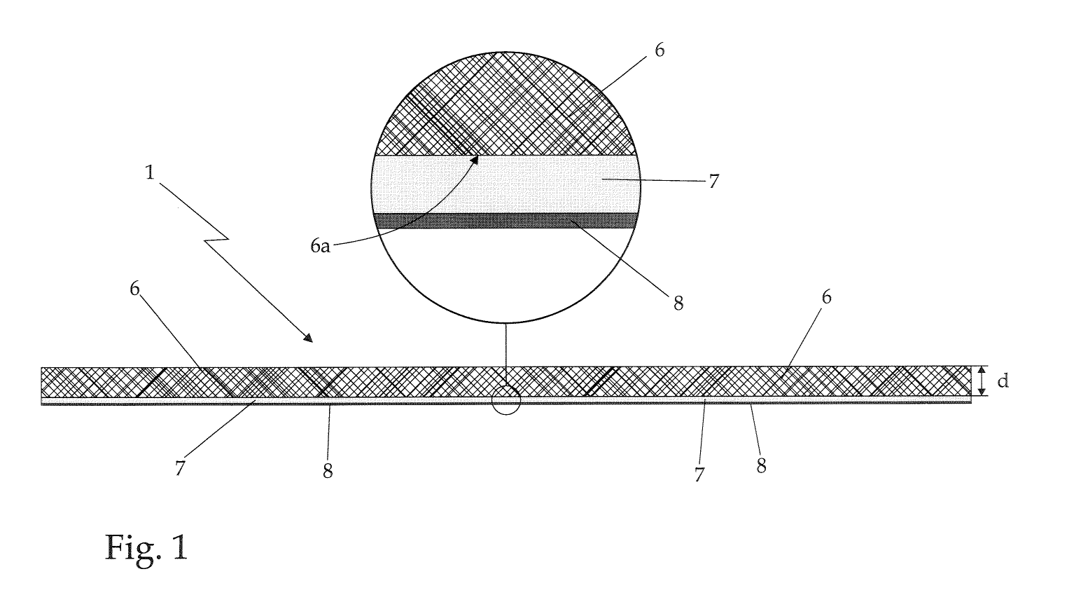

With reference to FIGS. 1 and 4, numeral 1 indicates as a whole a thermosetting-resin constraint film specifically designed for being used in the production of composit-material artefacts 2 having preferably, though not necessarily, a flat or tubular shape, and which are substantially formed by one or more overlapped layers of glass fibres and/or carbon fibres and/or aramidic fibres and/or cotton fibres and/or linen fibres and/or hemp fibres and/or fibres made of other organic or inorganic material, hereinafter indicated by numeral 3, appropriately overlapped or braided with one another and embedded in a matrix of epoxy, phenolic, polyester thermosetting resin or the like.

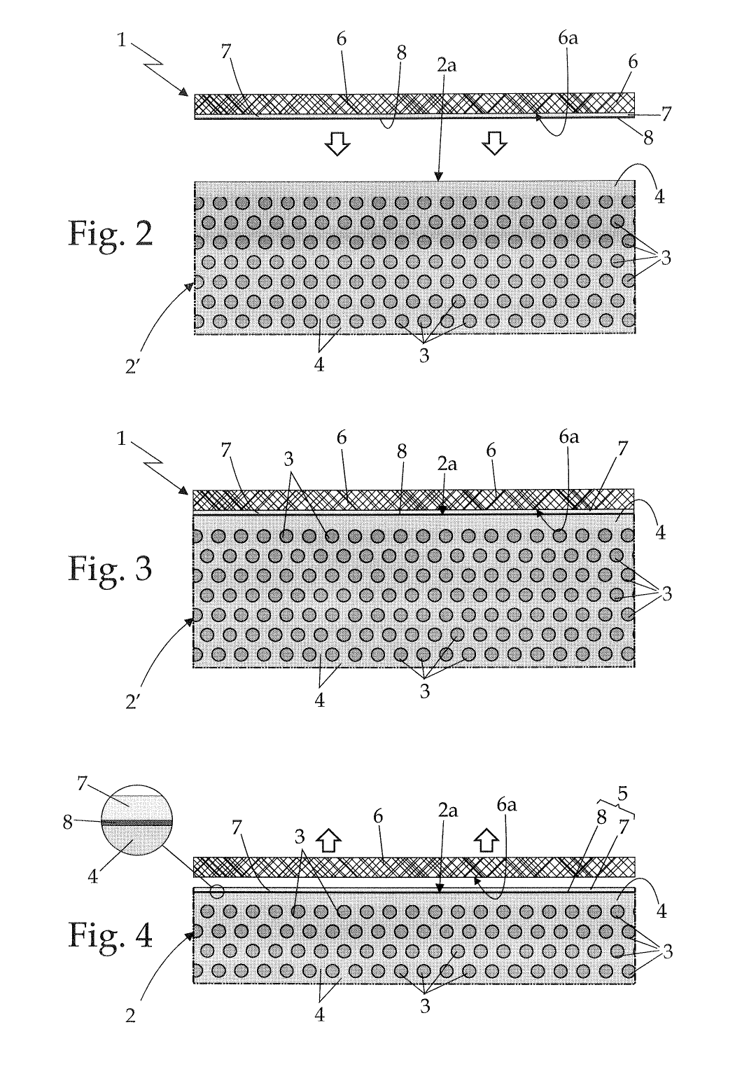

More specifically, with reference to FIGS. 1 and 2, the composit-material artefacts are manufactured by subjecting a semi-finished product 2′ which follows the shape of the composit-material artefact 2 to be realized and which is formed by one or more layers of fibres 3 impregnated with a thermosetting resin 4 still in a high viscosity liquid state, to a thermal curing cycle causing the polymerization of thermosetting resin 4 with a subsequent irreversible solidification thereof; and the constraint film 1, in the form of a tape or sheet, is designed so to be wound around the semi-finished product 2′ to keep the thermosetting resin 4 within the semi-finished product 2′ during the polymerization process.

In addition to the above, the constraint film 1 is also designed so to deposit, on outer surface 2a of semi-finished product 2′, a very thin outer coating film 5 which, at the end of the polymerization process of thermosetting resin 4, is permanently bounded to the surface of resulting composit-material artefact 2.

With reference to FIG. 1, constraint film 1 is substantially formed by a supporting film 6 which is preferably, though not necessarily, made of biaxially oriented polypropylene or by a similar plastic polymer; by an intermediate layer 7 of a release chemical product which totally coats the front face 6a of supporting film 6 intended to come into contact with semi-finished product 2′; and by a surface layer 8 of coating material which is homogeneous and preferably, though not necessarily, of a metal type, and which completely coats intermediate layer 7 and is realized via a vacuum vaporization deposition process.

More specifically, contrary to presently used solutions, film 6 is structured so that the plastic polymer which is located on the surface of the front face 6a intended to come into contact with semi-finished product 2′, locally has a surface tension Tₛ with a value preferably, though not necessarily, ranging between 45 Dyne/centimetre and 70 Dyne/centimetre, and in any case greater than 38 Dyne/centimetre; and so that the intermediate layer 7 of release chemical product is spread on front face 6a of film 6 via a flexo printing process or the like (such as for instance a process of screen, rotogravure, offset and rotoffset printing), so that the release chemical product binds to the surface of the underlying film 6 and can accept the following deposition by vacuum vaporization.

In other words, intermediate layer 7 of release chemical product is applied on the “treated” face of the film 6 made of polypropylene or the like, i.e. on the face that locally has a surface tension Tₛ with a value greater than 38 Dyne/centimetre.

In addition to the above, the thickness of the release chemical product forming the intermediate layer 7, must be preferably, though not necessarily, lower than the thickness d of the polypropylene film 6 by at least one order of magnitude.

Surface layer 8 is instead deposited directly on intermediate layer 7 via a vacuum vaporization deposition process, so that the metal coating material perfectly adheres to the intermediate layer 7, permanently binding to the release chemical product forming the intermediate layer, and so that the thickness of the coating metal material is preferably, though not necessarily, lower than 0.5 microns (i.e. 10⁻⁶ metres), that is lower than the thickness of intermediate layer 7.

In the example shown, in particular, constraint film 1 is produced from a biaxially oriented polypropylene film 6 with a thickness of about 35 microns, which undergoes a surface electrochemical treatment in which the surface of the front face 6a intended to come into contact with semi-finished product 2′, is immersed in a high intensity electrical field (corona treatment) or is bombarded with high-energy ionized particles, or is hit by a jet of cold plasma, or is licked by flames, so that surface tension Tₛ of the polypropylene locally has a value of about 50 Dyne/centimetre; while intermediate layer 7 is formed by a layer of transparent paint applied via flexo printing, such as for instance the transparent paint commercialized by the company FlintGroup Italia S.p.a. with the name PLURICEL RC ARL.

In this matter, it should be noted that, contrary to a coloured paint, a transparent paint only consists of a liquid mixture of resin and diluent/solvent finely mixed together, and is always substantially transparent because the chemical products forming it are substantially colourless.

As far as surface layer 8 of coating material is concerned, the production method of constraint film 1 provides that the coating material is deposited directly on intermediate layer 7 via the vacuum vaporization process, so that the final thickness of surface layer 8 is preferably, though not necessarily, lower than 0.5 microns (i.e. 10⁻⁶ metres). In the example shown, in particular, the coating material forming surface layer 8, consists of aluminium deposited directly on intermediate layer 7 via the vacuum vaporization process, so that the final thickness of surface layer 8 ranges between 0.005 and 0.01 microns.

As an alternative to aluminium, surface layer 8 may also be made of copper, chromium, silver, gold, platinum, steel, brass, nickel and alloys thereof, or other vaporizable metal materials, or non-metal materials such as silicon (possibly even amorphous), graphite, tetrafluoroethylene (also known as Teflon) or other plastic materials depositable via the vacuum vaporization process, so that the final thickness of surface layer 8 is preferably, though not necessarily, lower than 0.05 microns.

The vacuum vaporization process, also known as vacuum vaporization deposition process, is a technology which is already widely known and used in other fields, and will not therefore be further disclosed.

With reference to FIGS. 2, 3 and 4, composit-material artefact 2 is made via a production method that firstly provides to realize a semi-finished product 2′ which copies the shape of the composit-material artefact 2 to be realized, and which is formed by one or more layers of fibres 3 possibly braided together and impregnated with a thermosetting resin 4 still in a high viscosity liquid state.

Following to the realization of the semi-finished product 2′, the production method of composit-material artefacts provides for the outer surface 2a of semi-finished product 2′ to be completely covered with constraint film 1 (see FIG. 2), taking care that constraint film 1 is oriented so that surface layer 8 of the film is arranged in direct contact with semi-finished product 2′, and therefore in direct contact with the thermosetting resin 4 present on outer surface 2a of semi-finished product 2′.

After semi-finished product 2′ has been covered by constraint film 1 so to confine into the semi-finished product 2′ the thermosetting resin 4 which is still in a high viscosity liquid state, the production method of composit-material artefacts provides for the semi-finished artefact 2′ totally covered by the constraint film 1 (see FIG. 3) to undergo a thermal curing cycle so to cause the complete polymerization of thermosetting resin 4 with the subsequent irreversible solidification of the latter.

Obviously, the features of the thermal curing cycle depend on the type of thermosetting resin 4 used in the semi-finished product 2′.

Once polymerization of thermosetting resin 4 of semi-finished product 2′ is completed, the production method of composit-material artefacts provides for the semi-finished product 2′ to be extracted from the oven, and preferably, though not necessarily, then for the constraint film 1 to be removed from semi-finished product 2′, so to obtain a composit-material artefact 2 having the surface coated by a very thin outer film 5 which is formed by intermediate layer 7 and surface layer 8 of constraint film 1. During the polymerization process, thermosetting resin 4 of semi-finished product 2′ binds perfectly to surface layer 8 of constraint film 1, stably and permanently sticking surface layer 8 to the outer surface 2a of semi-finished product 2′.

The complete transfer of layers 7 and 8 on semi-finished product 2′ occurs because the molecular bonds established between surface layer 8 and intermediate layer 7 of constraint film 1 thanks to the vacuum vaporization deposition process, are much stronger than the molecular bonds established between intermediate layer 7 and the rest of constraint film 1 (i.e. film 6), therefore intermediate layer 7 can separate without fractures from the rest of constraint film 1 (i.e. from film 6) during the removal of constraint film 1.

Preferably, though not necessarily, after the polymerization of thermosetting resin 4 of semi-finished product 2′ is completed and constraint film 1 is removed from semi-finished product 2′, the production method of composit-material artefacts finally provides for the outer film 5 of resulting artefact 2 to be coated, on choice and alternatively, with a layer of transparent paint applied preferably, though not necessarily, by spray; with a layer of transparent thermosetting resin, and a new thermal curing cycle being consequently performed so as to cause the polymerization also of this second resin; or with a transparent film, possibly auto-adhesive, and made of polyurethane or other plastic polymer resin.

After having stably bonded to the outer film 5 of artefact 2, the layer of paint, the layer of resin or the plastic polymer film form a supplementary transparent surface layer, which serves to protect outer film 5 of artefact 2 from scratches and mechanical abrasions of any kind.

There are many advantages resulting from the use of the above-described constraint film 1.

First of all, being able to deposit surface layer 8 directly on the surface of the composit-material artefact 2, transforming said layer into the outer film 5 of the artefact, the constraint film 1 is able to colour the surface of artefact 2 with the colour typical of the material forming surface layer 8.

Since it is obtained by means of a homogeneous layer of coloured material, and not by means of a large amount of microscopical particles of pigment dispersed in the matrix of thermosetting resin, the colour on artefact 2 has an intensity, brightness and shine comparable to those that are obtained by painting the composit-material artefact, by spray or brush, at the end of the polymerization process of the thermosetting resin.

Furthermore, by using constraint film 1, it is possible to transfer onto the surface of artefact 2 the metal material forming surface layer 8, thus obtaining the outer film 5 of artefact 2 with the preselected material. Outer film 5 obtained thereby is uniform and compact, and has a metal-type surface finishing which is comparable to that which would be obtained by surface coating, electrolysis or vacuum deposition directly on the end product. By using constraint film 1, the surface of composit-material artefact 2 may also be ennobled with gold, silver and platinum, with particularly limited costs. The amount of valuable material per surface unit required to form the outer film 5 is indeed very low.

In addition to the above, by using constraint films 1 with surface layer 8 made of metal material, the surface of composit-material artefact 2 may be completely metallised thus making it electrically conductive. A feature which may not be obtained by traditional colouring methods in which the microscopical particles of pigment, even when made of electrically conductive metal material, remain in any case dispersed in the thermosetting resin which is well-known to be an excellent electrical insulator.

By using constraint films 1 with surface layer 8 made of Teflon, it is finally possible to confer to the surface of artefact 2 the anti-adhesive properties typical of such material.

Clearly, changes and variants may be made to constraint film 1, to its production method, and to the production method of composit-material artefacts 2 using this film, without however departing from the scope of the present invention.

For example, instead of being formed by transparent paint, intermediate layer 7 of release chemical product of constraint film 1 may be formed by a layer of coloured paint applied by means of flexo printing or the like, such as for instance the printing ink commercialized by the company FlintGroup Italia S.p.a. with the name DAILOX ARL.

Likewise to the coloured paint, in fact the printing ink is formed by a liquid and substantially transparent mixture of resin and diluent/solvent which are finely mixed together, and by a variable amount of basic pigment particles (i.e. finely ground particles of the desired colouring substance) suspended in the substantially transparent liquid mixture. The diluent/solvent serves to maintain the resin in a liquid state, while the resin is the chemical substance which grips to the surface of film 6 when it is still in a liquid phase, and which stably sticks to the surface of film 6 retaining the pigment particles when the diluent/solvent is naturally dispersed by evaporation.

The production method of composit-material artefacts may also be used to make composit-material artefacts with a multilayer surface structure.

In this case, after thermosetting resin 4 of the semi-finished product 2′ has completed the polymerisation, after constraint film 1 has been removed from the semi-finished product 2′ so as to form outer film 5 of artefact 2, and possibly after supplementary surface layer with protective function has been realized, the production method of composit-material artefacts could also provide the step of applying on the outer film 5 of artefact 2, or even on the supplementary surface layer with protective function, a second constraint film 1 which, at the end of the polymerization process of the underlying resin, would be incorporated in artefact 2 providing a surface covering with multiplayer structure.

Obviously, it would be possible to overlap two, three, four, or more constraint films 1 of different kinds, so that each single layer of the surface covering obtained on artefact 2 has the physical features (for instance electrical conductivity) of the material that forms the surface layer 8 of constraint film 1 used in the production process.

1. Constraint film to be used in production of composit-material artefacts, comprising a plastic polymer supporting film, an intermediate layer of release chemical product that coats the front face of the supporting film intended to come into contact with the semi-finished product (2′) which will give rise to the composit-material artefact, and a surface layer of coating material applied onto the intermediate layer via vacuum vaporization deposition.

2. A constraint film according to claim 1, characterised in that the supporting film is structured so that the plastic polymer which is located on the surface of the front face of the supporting film intended to come into contact with the semi-finished product (2′), locally has a surface tension (Ts) having a value greater than 38 Dyne/centimetre.

3. A constraint film according to claim 2, characterised in that the plastic polymer which is located on the surface of the front face of the supporting film, locally has a tension surface (T₃) having a value ranging between 45 Dyne/centimetre and 70 Dyne/centimetre.

4. A constraint film according to claim 1, characterised in that the supporting film is made of polypropylene.

5. A constraint film according to claim 4, characterised in that the supporting film is made of biaxially oriented polypropylene.

6. A constraint film according to claim 1, characterised in that the surface layer is made of metal material.

7. A constraint film according to claim 1, characterised in that the surface layer is made of silicon, graphite, Teflon or other materials which may be deposited via vacuum vaporization.

8. A constraint film according to claim 1, characterised in that the intermediate layer is formed by a layer of transparent or coloured paint which is spread on the front face of the supporting film via a flexo printing process or the like; the thickness of the intermediate layer being lower than the thickness (d) of the supporting film by at least one order of magnitude.

9. Production method of a resin constraint film to be used in the production of composit-material artefacts; the method comprising
realizing, via a flexo printing process or the like, a first layer of a release chemical product on the surface of a plastic polymer supporting film, coating the front face of the film intended to come into contact with the semi-finished product (2′) which will give rise to the composit-material artefact; and
realizing, via a vacuum vaporization deposition, a second layer of coating material over the first layer of release chemical product.

10. A production method of a constraint film according to claim 9, also comprising, before realizing said first layer, subjecting the front face of the supporting film to a surface treatment so that the plastic polymer which is located on the surface of said front face locally has a surface tension (T₃) having a value greater than 38 Dyne/centimetre.

11. A production method of a constraint film according to claim 10, characterised in that, at the end of said surface treatment, the plastic polymer which is located on the surface of the front face of the supporting film, locally has a tension surface (T₃) having a value ranging between 45 and 70 Dyne/centimetre.

12. A production method of a constraint film according to claim 9, characterised in that the supporting film is made of polypropylene.

13. A production method of a constraint film according to claim 12, characterised in that the supporting film is made of biaxially oriented polypropylene.

14. A production method of a constraint film according to claim 9, characterised in that the second layer is made of metal material.

15. A production method of a constraint film according to claim 9, characterised in that the second layer is made of silicon, graphite, Teflon or other materials which may be deposited via vacuum vaporization.

16. A production method of a constraint film according to claim 9, characterised in that the first layer is formed by a layer of transparent or coloured paint with a thickness smaller than the thickness (d) of the supporting film.

17. Production method of composit-material artefacts formed by one or more overlapped layers of fibres of organic or inorganic material, embedded in a matrix of thermosetting resin; the method comprising, in sequence,
realizing a semi-finished product (2′) which follows the shape of the composit-material artifact to be manufactured, and which is formed by one or more layers of said fibres impregnated with a thermosetting resin still in a high viscosity liquid state;
covering at least one surface of the semi-finished product (2′) with a constraint film which is manufactured according to claim 1, so to confine the thermosetting resin still in a high viscosity liquid state within the semi-finished product (2′), further taking care that said constraint film is oriented so that its surface layer is arranged in direct contact with the semi-finished product (2′); and finally
subjecting the semi-finished product (2′) covered by the constraint film to a thermal curing cycle so as to cause the polymerization of the thermosetting resin with the subsequent irreversible solidification thereof.

18. A production method of composit-material artefacts according to claim 17, also comprising, once the polymerization of the thermosetting resin is completed, removing the constraint film from the semi-finished product (2′), so that the constraint film leaves its surface layer stably stuck on said surface of the semi-finished product (2′), so as to form thereon an outer coating film.

19. A production method of composit-material artefacts according to claim 18, also comprising, once the constraint film is removed from the semifinished product (2′), applying on the outer coating film of the resulting artefact, a layer of transparent paint, or a layer of thermosetting transparent resin, or a transparent plastic polymer film.
